(19) United States
(12) Patent Application Publication
(10) Pub. No.: US 2026/0067753 A1
(43) Pub. Date: Mar. 5, 2026

(54) ELECTRONIC DEVICE, CONTROL METHOD FOR THE SAME, AND STORAGE MEDIUM

(71) Applicant: CANON KABUSHIKI KAISHA, Tokyo (JP)

(72) Inventor: TAKAFUMI ISHII, Kanagawa (JP)

(21) Appl. No.: 19/290,835

(22) Filed: Aug. 5, 2025

(30) Foreign Application Priority Data
Aug. 28, 2024 (JP) 2024-146776

(51) Int. Cl. H04W 28/18; H04W 76/15

(52) U.S. Cl. CPC H04W 28/18; H04W 76/15

(57) ABSTRACT

An electronic device having a communication device capable of communication using a first communication method of wirelessly communicating with an external device via an external access point, and communication using a second communication method of wirelessly communicating directly with an external device without going through an external access point. The electronic device enables both a first version and a second version of the second communication method in a case where the communication using the second communication method is enabled while the first communication method is disabled, and enables one of the first version and the second version of the second communication method in a case where the communication using the second communication method is enabled while the first communication method is enabled.

### BACKGROUND

### Field of the Technology

The present disclosure relates to an electronic device, a control method for the same, and a storage medium.

### Description of the Related Art

In recent years, the development of communication technologies such as wireless LANs (Local Area Networks) has progressed accompanying an increase in the amount of data being communicated. The IEEE (Institute of Electrical and Electronic Engineers) 802.11 standard series is known as the main communication standard for wireless LANs. The IEEE 802.11 standard series includes IEEE 802.11a/b/g/n/ac/ax standards and the like. For example, the latest standard, IEEE 802.11ax, uses orthogonal frequency division multiple access (OFDMA) to standardize technology that achieves a high peak throughput of up to 9.6 gigabits per second (Gbps) and improves communication speed in congested situations. OFDMA stands for Orthogonal Frequency-Division Multiple Access.

Meanwhile, the Wi-Fi Alliance has developed a program for authenticating wireless LAN devices. For example, a WFD standard has been established that defines a procedure for establishing a communication link between wireless LAN stations (STAs) by exchanging communication parameters between the STAs without going through an access point (AP). Here, the WFD includes standards referred to as WFD R1 and WFD R2. WFD stands for Wi-Fi Direct (registered trademark).

In addition, the Wi-Fi Aware standard has also been developed, which is a standard for discovering services provided by devices. For example, Japanese Patent Application Laid-Open No. 2019-201427 describes detecting a communication terminal using the provisions of the Wi-Fi Aware standard. In addition, there is a technology for stopping one of a plurality of functions under a certain condition in a case where the plurality of functions are operating at the same time. For example, Japanese Patent Application Laid-Open No. 2023-173887 describes that in a case where a wireless infrastructure mode and a wireless direct mode operate at the same time and the channels used match, the wireless direct mode is stopped.

In the case of a weak wireless chip, when the wireless infrastructure, WFD R1, and WFD R2 are operated in parallel, it may be difficult to operate the three functions simultaneously, or each function may not be able to achieve sufficient performance.

### SUMMARY

In order to solve the above problem, according to one aspect of the present disclosure, there is provided an electronic device comprising: a communication device capable of communication using a first communication method of wirelessly communicating with an external device via an external access point, and communication using a second communication method of wirelessly communicating directly with an external device without going through an external access point; at least one memory storing instructions; and at least one processor that is in communication with the at least one memory and that, when executing the instructions, cooperates with the at least one memory to execute processing, the processing including enabling both a first version and a second version of the second communication method in a case where the communication using the second communication method is enabled while the first communication method is disabled, and enabling one of the first version and the second version of the second communication method in a case where the communication using the second communication method is enabled while the first communication method is enabled.

According to the present disclosure, even in an electronic device that employs a weak wireless chip with low processing capability, by limiting the number of functions that can be activated at the same time to two, it is possible to prevent a decrease in the performance of each function.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an example of a system configuration.

FIG. 2A is a diagram showing an example of an external appearance of an MFP.

FIG. 2B is a diagram showing an example of a configuration of an MFP.

FIGS. 3A to 3C are diagrams showing examples of displays on an operation display unit of the MFP.

FIG. 4A is a diagram showing an external appearance of a mobile terminal device.

FIG. 4B is a diagram showing a configuration of the mobile terminal device.

FIG. 5 is a diagram illustrating a configuration of an access point.

FIG. 6 is a sequence diagram illustrating connection processing according to a conventional WFD standard.

FIG. 7 is a sequence diagram illustrating connection processing of a new WFD standard.

FIGS. 8A to 8C are diagrams showing examples of guide screen displays that notify the user when WFD is enabled on the MFP.

FIG. 9A is a flowchart showing processing performed when the MFP operates two functions at the same time.

FIG. 9B is a flowchart showing processing performed when the MFP operates two functions at the same time.

### DESCRIPTION OF THE EMBODIMENTS

Hereinafter, an embodiment of the present disclosure will be described in detail with reference to the drawings. Note that the present embodiment is merely an example, and specific examples of constituent components, processing steps, display screens, and the like are not intended to limit the scope of the present invention unless otherwise specified.

### System Configuration

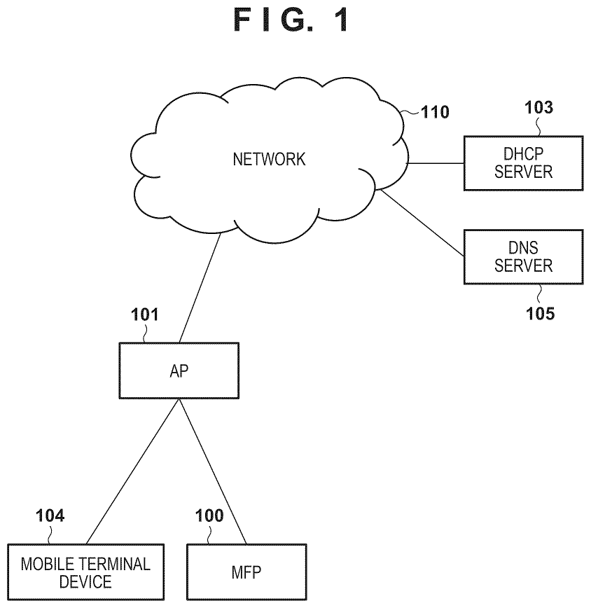

FIG. 1 shows an example of a configuration of a system according to this embodiment. In one example, the system is a wireless communication system in which a plurality of communication devices can wirelessly communicate with each other. In the example of FIG. 1, the communication devices include a mobile terminal device 104, an MFP 100, an AP 101, which is an access point, a DHCP server 103, and a network 110. The mobile terminal device 104 is a device having a wireless communication function such as a wireless LAN. Note that in the following, a wireless LAN is referred to as a WLAN in some cases. The mobile terminal device 104 may be a personal digital assistant such as a PDA (Personal Digital Assistant), a mobile phone (smartphone), a digital camera, a personal computer, or the like.

The MFP 100 is a printing device having a printing function, and may further have a reading function (scanner), a FAX function, and a telephone function. In addition, the MFP 100 of the present embodiment has a communication function that enables wireless communication with the mobile terminal device 104. In addition, in the present embodiment, a case where the MFP 100 is used will be described as an example, but there is no limitation to this. For example, a scanner device, a projector, a mobile terminal, a smartphone, a notebook PC, a tablet terminal, a PDA, a digital camera, a music playback device, a television, a smart speaker, and the like, each having a communication function, may be used instead of the MFP 100. Note that MFP is an acronym for Multi Function Peripheral.

The AP 101 is provided separately (externally) from the mobile terminal device 104 and the MFP 100, and operates as a base station device of the WLAN. A communication device having a WLAN communication function can communicate in a WLAN infrastructure mode via the AP 101. Note that hereinafter, an access point may is referred to as an “AP” in some cases. The infrastructure mode is also be called a “wireless infrastructure mode” in some cases. The AP 101 performs wireless communication with a communication device that has been permitted to connect to the AP 101 (a communication device that has been authenticated), and relays wireless communication between that communication device and other communication devices. In addition, the AP 101 may be connected to, for example, a wired communication network, and may relay communication between a communication device connected to the wired communication network and another communication device wirelessly connected to the AP 101.

The DHCP server 103 connects to the MFP 100 via the AP 101 and the network 110, and provides a service to the MFP 100 by responding to a request from the MFP 100. Note that in FIG. 1, the DHCP server 103 is described as having a configuration in which it is connected as a separate device from the AP 101, but the AP 101 may also have a DHCP server function. The DNS server 105 is connected to the MFP 100 and the mobile terminal device 104 via the AP 101 and the network 110, and provides a service for name resolution by responding to requests from the MFP 100 and the mobile terminal device 104. Here, the network 110 may be what is called the Internet, or may be a closed network within a company or a mobile phone network.

### External Configuration of MFP

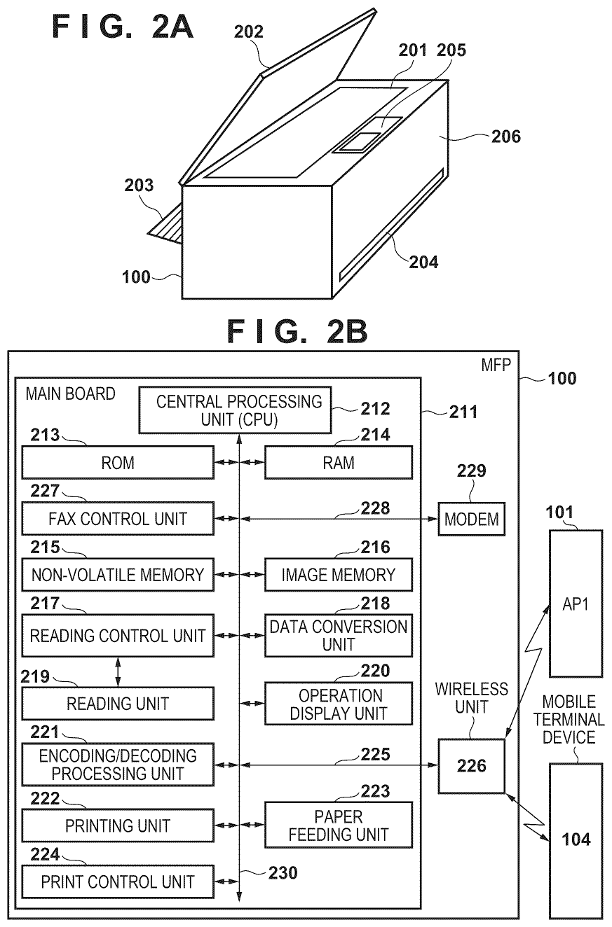

FIG. 2A shows an example of the external configuration of the MFP 100. The MFP 100 includes, for example, a document platen 201, a document cover 202, a print sheet insertion port 203, a print sheet discharge port 204, and an operation display unit 205. The document platen 201 is a platen on which a document to be read is placed. The document cover 202 is a cover for holding down the document placed on the document platen 201 and for preventing light from a light source that irradiates the document during reading from leaking out. The print sheet insertion port 203 is an insertion port in which sheets of various sizes can be set. The print sheet discharge port 204 is a discharge port through which a sheet is discharged after printing is complete. The sheets set in the print sheet insertion port 203 are transported one by one to a printing section where printing is carried out, and then are discharged from the print sheet discharge port 204. The operation display unit 205 includes keys such as character input keys, cursor keys, a decision key, and a cancel key, as well as an LED, an LCD, and the like, and is configured to be able to accept a user operation for starting up various functions of the MFP and for performing various settings. The operation display unit 205 may also be configured to include a touch panel display. The MFP 100 has a wireless communication function based on WLAN, and includes a wireless communication antenna 206 for this wireless communication, although this does not necessarily need to be visible from the outside. As with the mobile terminal device 104, the MFP 100 can also perform wireless communication via WLAN in the 2.4-GHz, 5-GHz, and 6-GHz frequency bands.

### Configuration of MFP

FIG. 2B shows an example of the configuration of the MFP 100. The MFP 100 includes a main board 211 that performs main control of the MFP 100 itself, and a wireless unit 226 that is one communication module that performs WLAN communication using at least one common antenna. The MFP 100 also includes, for example, a modem 229 for performing wired communication. The main board 211 includes, for example, a CPU 212 (central processing unit), a ROM 213, a RAM 214, a non-volatile memory 215, an image memory 216, a reading control unit 217, a data conversion unit 218, a reading unit 219, and an encoding/decoding processing unit 221. The main board 211 also includes, for example, a printing unit 222, a paper feeding unit 223, a print control unit 224, and an operation display unit 220. These functional units within the main board 211 are connected to each other via a system bus 230 managed by the CPU 212. In addition, the main board 211 and the wireless unit 226 are connected via, for example, a dedicated bus 225, and the main board 211 and the modem 229 are connected via, for example, a bus 228.

The CPU 212 is a system control unit that includes at least one processor, and controls the entire MFP 100. In one example, the processing of the MFP 100 described below is realized by the CPU 212 executing a program stored in the ROM 213. Note that dedicated hardware for each process may also be provided. The ROM 213 stores the control program to be executed by the CPU 212, the embedded OS program, and the like. In this embodiment, the CPU 212 executes each control program stored in the ROM 213 under the management of an embedded OS also stored in the ROM 213, thereby performing software control such as scheduling and task switching.

The RAM 214 is constituted by an SRAM or the like. The RAM 214 stores data such as program control variables, setting values registered by the user, management data for the MFP 100, and the like. In addition, the RAM 214 can be used as a buffer for various types of work. The non-volatile memory 215 is constituted by a memory such as a flash memory, and continues to store data even when the MFP 100 is powered off. The image memory 216 is constituted by a memory such as a DRAM. The image memory 216 accumulates image data received via the wireless unit 226, image data processed by the encoding/decoding processing unit 221, and the like. Note that the memory configuration of the MFP 100 is not limited to the above-mentioned configuration. The data conversion unit 218 analyzes data in various formats and converts image data into print data.

The reading control unit 217 controls the reading unit 219 (e.g., a contact image sensor (CIS)) to optically read a document placed on the document platen 201. The reading control unit 217 converts an image obtained by optically reading the document into electrical image data (image signals) and outputs the same. At this time, the reading control unit 217 may output the image data after performing various types of image processing such as binarization and halftoning.

The operation display unit 220 is the operation display unit 205 described with reference to FIG. 2A, and executes display on a display based on display control by the CPU 212, generation of a signal in response to reception of a user operation, and the like.

The encoding/decoding processing unit 221 performs encoding processing, decoding processing, and enlargement/reduction processing on image data (JPEG, PNG, etc.) handled by the MFP 100.

The paper feeding unit 223 holds sheets for printing. The paper feeding unit 223 can supply the set sheets under the control of the print control unit 224. The paper feeding unit 223 may include a plurality of paper feed units in order to hold a plurality of types of paper in one device, and under the control of the print control unit 224, it is possible to control which paper feeding unit to use to feed paper.

The print control unit 224 performs various types of image processing such as smoothing, print density correction, and color correction on the image data to be printed, and outputs the processed image data to the printing unit 222. The printing unit 222 is configured to be able to execute printing processing using, for example, an inkjet method, and ejects ink supplied from an ink tank from a print head to record an image on a recording medium such as a sheet. Note that the printing unit 222 may also be configured to be able to execute other printing processing using an electrophotographic method or the like. In addition, the print control unit 224 can periodically read out information from the printing unit 222 and update status information and the like stored in the RAM 214, including the remaining ink levels in the ink tanks, the state of the print heads, and the like.

The wireless unit 226 is a unit capable of providing a WLAN communication function, and can provide the same functions as a combination of the WLAN unit 401 of the mobile terminal device 104, for example. That is, the wireless unit 226 converts data into packets in accordance with the WLAN standard and transmits the packets to other devices, and further restores packets from other external devices to the original data and outputs the result to the CPU 212. The wireless unit 226 is capable of communicating as a station conforming to the IEEE 802.11 standard series. In particular, it is possible to communicate as a station conforming to IEEE 802.11a/b/g/n/ac/ax. In the following, a station may be referred to as an STA.

The wireless unit 226 is compatible with IEEE 802.11ax, that is, Wi-Fi 6 (trademark), and can perform processing conforming to IEEE 802.11ax. That is, the MFP 100 is capable of performing either or both of the operations (processing) of an STA compatible with (or conforming to) OFDMA and the operations (processing) of an STA compatible with (or conforming to) TWT. OFDMA stands for Orthogonal Frequency-Division Multiple Access. TWT stands for Target Wake Time. Since TWT is supported, the timing of data communication from a master device to the STA is adjusted. The wireless unit 226 (MFP 100), which is an STA, transitions its communication function to a sleep state when there is no need to wait for signal reception. This makes it possible to reduce power consumption. In addition, the wireless unit 226 also supports Wi-Fi 6E (trademark). That is, communication in the 6-GHz band (5.925 GHz to 7.125 GHz) is also possible. The bands in the 5-GHz band that are subject to Dynamic Frequency Selection (DFS) do not exist in the 6-GHz band. For this reason, when communicating in the 6-GHz band, communication interruptions due to DFS waiting times will not occur, and smoother communication can be expected. Here, it is assumed that processing is performed in conformity with IEEE 802.11ax, but the mobile terminal device 104 and the MFP 100 may operate in conformity with another standard of the IEEE 802.11 series. For example, they may also conform to the IEEE 802.11be or later standards.

Note that the mobile terminal device 104 and the MFP 100 are capable of P2P (WLAN) communication based on WFD, and the wireless unit 226 has a software access point (soft AP) function or a group owner function. That is, the wireless unit 226 can build a network for P2P communication and determine the channel to be used for P2P communication. WFD here is based on the standard established by the Wi-Fi Alliance. The wireless unit 226 can also operate as a WFD client.

### Operation Display Unit of MFP

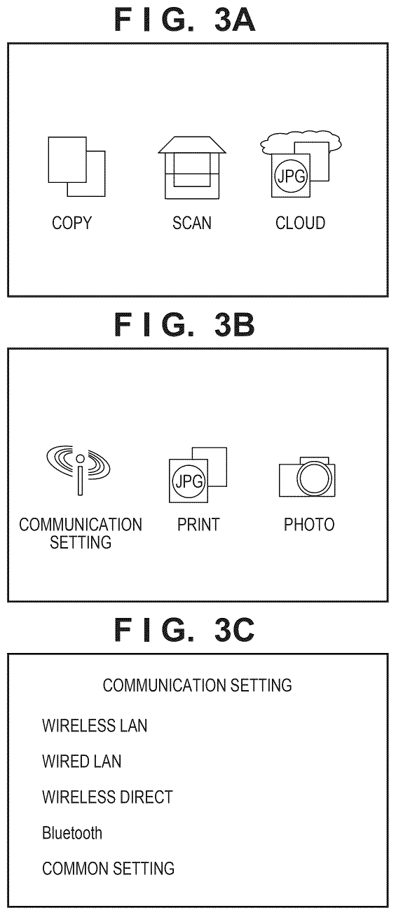

FIGS. 3A to 3C schematically show examples of screen displays on a display (touch panel display) included in the operation display unit 220 of the MFP 100. FIG. 3A is an example of a home screen that is displayed when the MFP 100 is powered on and no operation such as printing or scanning is being performed (idle state, Standby state). In FIG. 3A, display items (menu items) corresponding to copy, scan, and cloud are displayed. Cloud is a menu item relating to cloud functions that utilize internet communication. When any of the menu items is selected through key operation or touch panel operation, the MFP 100 can start executing the corresponding setting or function. The MFP 100 can seamlessly display a screen different from that shown in FIG. 3A by accepting a key operation or touch panel operation on the home screen shown in FIG. 3A.

FIG. 3B is a display example of another part of the home screen, and is a screen that is transitioned to from the state of FIG. 3A by performing an operation to display another page of the home screen (a sliding operation to the left or right, etc.). In FIG. 3B, display items (menu items) corresponding to communication setting, print, and photo are displayed. When any of these menu items is selected, the function corresponding to the selected menu item, that is, the print function, photo function, or communication setting function, is executed.

FIG. 3C is an example of display of a communication setting menu screen that is displayed in the case where communication setting is selected on the screen of FIG. 3B. The communication setting menu screen displays the following menu items (options): “wireless LAN”, “wired LAN”, “wireless direct”, “Bluetooth”, and “common”. “Wireless LAN”, “wired LAN”, and “wireless direct” are menu items for performing LAN settings, and from these items, it is possible to perform settings such as a setting for a wired connection, a setting to enable/disable a wireless infrastructure mode, and a setting to enable/disable a P2P mode such as WFD or a soft AP mode. In a case where the “wireless LAN” item is selected and the wireless LAN is enabled through a user operation, the wireless infrastructure mode is enabled. In a case where the “wireless direct” item is selected and wireless direct is enabled by a user operation, the P2P (WLAN) mode is enabled. This screen also displays a common setting menu for each connection mode. Furthermore, the user can set the frequency band and frequency channel of the wireless LAN and the like from this screen.

### External Configuration of Mobile Terminal Device

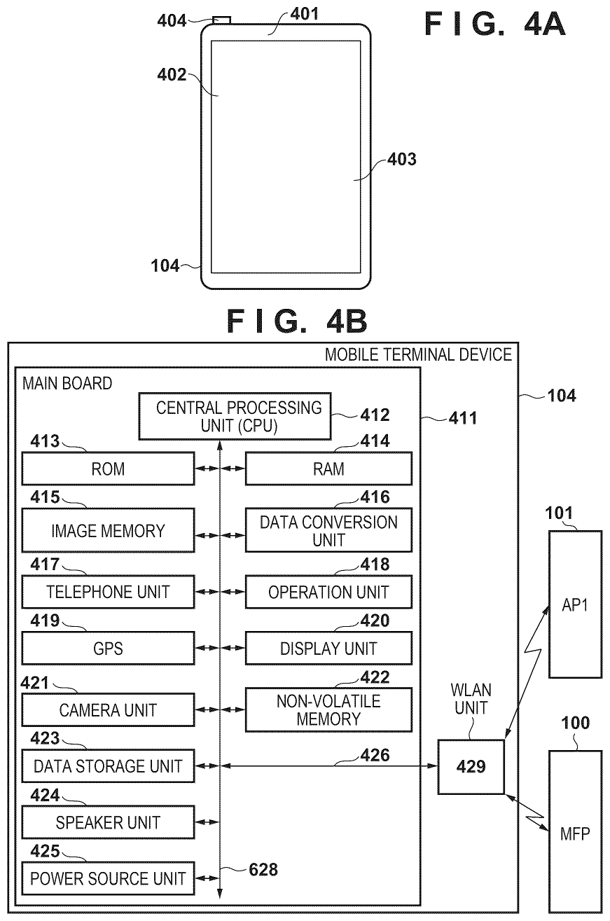

FIG. 4A is a diagram showing an example of an external configuration of the mobile terminal device 104. In this embodiment, as an example, a case is shown in which the mobile terminal device 104 is a general-format smartphone. Note that the mobile terminal device 104 includes, for example, a display unit 402, an operation unit 403, and a power key 404. The display unit 402 is, for example, a display including a display mechanism of a Liquid Crystal Display (LCD) method. Note that the display unit 402 may also display information using, for example, a Light Emitting Diode (LED) or the like. Also, in addition to or instead of the display unit 402, the mobile terminal device 104 may have a function of outputting information by audio. The operation unit 403 includes a hardware keyboard including keys and buttons, a touch panel, and the like for detecting user operations. Note that in this example, since a common touch panel display is used for displaying information on the display unit 402 and accepting a user operation performed using the operation unit 403, the display unit 402 and the operation unit 403 are realized by a single device. In this case, for example, button icons and a software keyboard are displayed using the display function of the display unit 402, and the operation acceptance function of the operation unit 403 detects that the user has touched these locations. Note that the display unit 402 and the operation unit 403 may be separated, and hardware for display and hardware for accepting an operation may be provided separately. The power switch 404 is a switch for accepting a user operation for powering the mobile terminal device 104 on or off.

The mobile terminal device 104 includes a WLAN unit 401 that provides a communication function for WLAN, although this does not necessarily need to be visible from the outside. The WLAN unit 401 is configured to be able to perform data (packet) communication in a WLAN system that conforms to, for example, the IEEE 802.11 standard series (IEEE 802.11a/b/g/n/ac/ax, etc.). It is also possible for the device to communicate as an AP that supports Wi-Fi Agile Multiband (trademark). However, there is no limitation to this, and the WLAN unit 401 may be capable of executing communication in a WLAN system conforming to another standard. Note that in this example, it is assumed that the WLAN unit 401 is capable of communicating in the 2.4-GHz, 5-GHz, and 6-GHz frequency bands. In addition, the WLAN unit 401 is capable of performing communication based on WFD, communication in a soft AP mode, communication in a wireless infrastructure mode, and the like. Operation in these modes will be described later.

### Configuration of Mobile Terminal Device

FIG. 4B shows an example of a configuration of the mobile terminal device 104. In one example, the mobile terminal device 104 includes a main board 411 that performs main control of the mobile terminal device 104 itself, and a WLAN unit 429 that performs WLAN communication. The main board 411 includes, for example, a CPU 412, a ROM 413, a RAM 414, an image memory 415, a data conversion unit 416, a telephone unit 417, a GPS 419, a camera unit 421, a non-volatile memory 422, a data storage unit 423, a speaker unit 424, and a power source unit 425. Here, CPU is an acronym for Central Processing Unit, ROM is an acronym for Read Only Memory, RAM is an acronym for Random Access Memory, and GPS is an acronym for Global Positioning System. The mobile terminal device 104 also includes a display unit 420 and an operation unit 418. These functional units within the main board 411 are connected to each other via a system bus 628 managed by the CPU 412. Also, the main board 411 and the WLAN unit 429 (the above-mentioned WLAN unit 401) are connected to each other via a dedicated bus 426, for example.

The CPU 412 is a system control unit that includes at least one processor, and performs overall control of the mobile terminal device 104. In one example, the processing of the mobile terminal device 104 described below is realized by the CPU 412 executing a program stored in the ROM 413. Note that dedicated hardware for each processing may also be provided. The ROM 413 stores the control program executed by the CPU 412, an embedded operating system (OS) program, and the like. In this embodiment, the CPU 412 executes each control program stored in the ROM 413 under the management of an embedded OS also stored in the ROM 413, thereby performing software control such as scheduling and task switching.

The RAM 414 is constituted by a Static RAM (SRAM) or the like. The RAM 414 stores data such as program control variables, setting values registered by the user, and management data for the mobile terminal device 104. Also, the RAM 414 can be used as a buffer for various types of work. The image memory 415 is constituted by a memory such as a Dynamic RAM (DRAM). The image memory 415 temporarily stores image data received via the WLAN unit 429 and image data read out from the data storage unit 423 for processing by the CPU 412. The non-volatile memory 422 is constituted by, for example, a memory such as a flash memory, and continues to store data even when the mobile terminal device 104 is powered off. Note that the memory configuration of the mobile terminal device 104 is not limited to the above-mentioned configuration. For example, the image memory 415 and the RAM 414 may be shared, and the data storage unit 423 may be used to back up data or the like. In addition, in this embodiment, a DRAM is given as an example of the image memory 415, but other storage media such as a hard disk or a non-volatile memory may also be used.

The data conversion unit 416 performs data conversion such as analysis of data in various formats, color conversion, and image conversion. The telephone unit 417 controls a telephone line and processes audio data input and output via the speaker unit 424, thereby realizing telephone communication. The GPS 419 receives radio waves transmitted from satellites and acquires location information such as the current latitude and longitude of the mobile terminal device 104.

The camera unit 421 has a function of electronically recording and encoding an image input via a lens. Image data obtained through image capture by the camera unit 421 is stored in the data storage unit 423. The speaker unit 424 performs control to realize a function of inputting or outputting audio for a telephone function, and other functions such as an alarm notification function. The power source unit 425 is, for example, a portable battery, and controls power supply to the device. The power source state includes, for example, a dead battery state in which the battery has no remaining power, a power-off state in which the power key 404 has not been pressed, a running state in which the device is normally running, and a power-saving state in which the device is running but is in a power saving mode.

The display unit 420 is the display unit 402 described with reference to FIG. 4A, and performs various input operations and displays the operating status and the status of the MFP 100 based on the control of the CPU 412. The operation unit 418 is the operation unit 403 described with reference to FIG. 4A, and upon accepting a user operation, the operation unit 418 executes control such as generating an electrical signal corresponding to the operation and outputting it to the CPU 412.

The mobile terminal device 104 performs wireless communication using the WLAN unit 429, and performs data communication with other devices such as the MFP 100. The WLAN unit 429 converts the data into packets and transmits the packets to other devices. In addition, the WLAN unit 429 restores packets from other external devices to the original data and outputs the data to the CPU 412. The WLAN unit 429 is a unit for realizing communication conforming to the WLAN standard. The WLAN unit 429 can operate in at least two communication modes in parallel, including a wireless infrastructure mode and a P2P (WLAN) mode. Note that the frequency bands used in these communication modes may be limited by the functionality and performance of the hardware.

### Configuration of Access Point

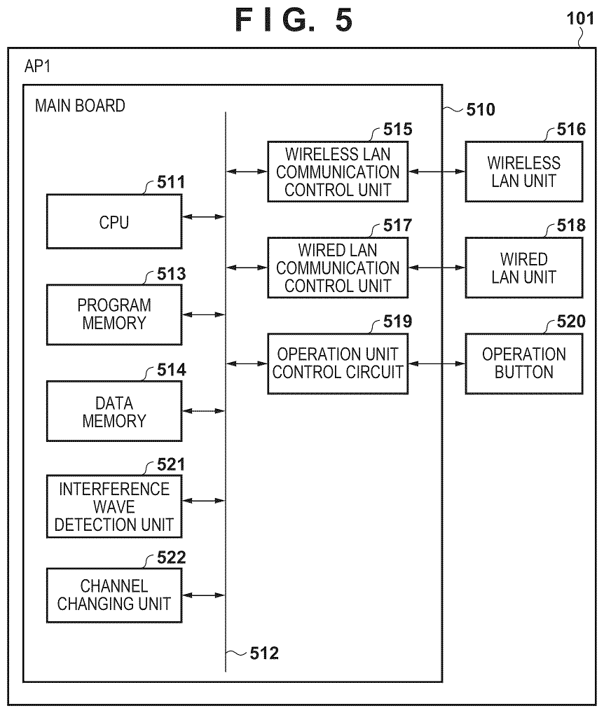

FIG. 5 is a block diagram showing the configuration of an AP 101 having a wireless LAN access point function. The AP 101 includes a main board 510 that controls the AP 101, a wireless LAN unit 516, a wired LAN unit 518, and an operation button 520.

A microprocessor-type CPU 511 disposed on the main board 510 operates according to a control program stored in a ROM-type program memory 513 connected via an internal bus 512 and the contents of a RAM-type data memory 514. The CPU 511 controls the wireless LAN unit 516 through a wireless LAN communication control unit 515 to perform wireless LAN communication with another communication terminal device. Also, the CPU 511 controls the wired LAN unit 518 via a wired LAN communication control unit 517 to perform wired LAN communication with another communication terminal device. The CPU 511 controls an operation unit control circuit 519 to be able to accept an operation from a user via the operation button 520. The CPU 511 includes at least one processor.

The AP 101 also includes an interference wave detection unit 521 and a channel changing unit 522. The interference wave detection unit 521 performs processing for detecting an interference wave when wireless communication is being performed in a band in which Dynamic Frequency Selection (DFS) is implemented. The channel changing unit 522 performs processing for changing the channel to be used in the case where, for example, an interference wave is detected while wireless communication is being performed in a band in which DFS is implemented and it is necessary to immediately change to an available channel.

### P2P Communication Method

Next, an overview of the P2P (WLAN) communication method, which allows devices to communicate directly with each other wirelessly without going through an external access point in WLAN communication, will be described. P2P (WLAN) communication can be realized using a plurality of techniques, and for example, a communication device can support a plurality of modes for P2P (WLAN) communication and selectively use one of the plurality of modes to perform P2P communication (WLAN).

The following two P2P modes are envisioned:
Soft AP mode
Wi-Fi Direct (WFD) Mode

A communication device capable of executing P2P communication may be configured to support at least one of these modes. On the other hand, even a communication device capable of executing P2P communication does not need to support all of these modes, and may be configured to support only some of them.

A communication device (e.g., the mobile terminal device 104) having a communication function based on WFD accepts a user operation via its operation unit, and calls up an application (in some cases, a dedicated application) for realizing the communication function. Then, this communication device can display a screen of a UI (user interface) provided by the application to prompt a user to perform an operation, and can execute WFD communication based on the user operation accepted in response thereto.

### Soft AP Mode

In the soft AP mode, a communication device (e.g., the mobile terminal device 104) operates in the role of a client that requests various services. The other communication device (e.g., the MFP 100) operates as a soft AP that can execute the functions of a WLAN AP by software settings. Note that the commands and parameters transmitted and received in the case of establishing a wireless connection between a client and a soft AP need only be those specified in the Wi-Fi (registered trademark) standard, and therefore they will not be described here. In addition, the MFP 100 operating in the soft AP mode determines the frequency band and frequency channel as the master station. For this reason, the MFP 100 can select which frequency band to use out of 2.4 GHz, 5 GHz, or 6 GHz, and which frequency channel to use within that frequency band. In the soft AP mode, there is no negotiation to determine roles, and it need not conform to the WFD standard established by the Wi-Fi Alliance.

### WFD Mode

The MFP 100 may be configured to start up as a fixed master station in the WFD mode (Autonomous Group Owner). In this case, GO Negotiation processing for determining the role is not required. Also, in this case, the MFP 100 determines the frequency band and frequency channel as the master station. For this reason, the MFP 100 can select which frequency band to use out of 2.4 GHz, 5 GHz, or 6 GHz, and which frequency channel to use within that frequency band. In addition, in the WFD mode, a configuration may be adopted in which negotiation (GO Negotiation) is performed to determine which device will operate as the group owner and which device will operate as the client.

### Wireless Infrastructure Mode

In the wireless infrastructure mode, communication devices (e.g., the mobile terminal device 104 and the MFP 100) that communicate with each other are connected to an external AP (e.g., the AP 101) that controls the network, and communication between the communication devices is performed via that AP. In other words, communication between the communication devices is executed via a network constructed by an external AP. When the mobile terminal device 104 and the MFP 100 each discover the AP 101 and transmit a connection request to the AP 101 to connect thereto, communication between these communication devices becomes possible in the wireless infrastructure mode via the AP 101. Note that a plurality of communication devices may also be connected to separate APs. In this case, data transfer is performed between the APs, enabling communication between the communication devices. Regarding the commands and parameters transmitted and received during communication between each communication device via an access point, it is sufficient to use those defined in the Wi-Fi standard, and therefore description thereof will be omitted here. In this case, the AP 101 determines the frequency band and the frequency channel. For this reason, the AP 101 can select which frequency band to use from 2.4 GHz, 5 GHz, or 6 GHz, and which frequency channel to use within that frequency band.

Here, it is assumed that the WFD includes both the conventional standard method and the new standard method. That is, it is assumed that the WFD standard includes a plurality of methods with different standard versions. The conventional method of WFD will be called WFD R1, and the new method of WFD will be called WFD R2. The methods of discovering devices and exchanging parameters are different between WFD R1 and WFD R2.

### Connection Processing of Conventional WFD Standard

The mobile terminal device 104 and the MFP 100 support a function disclosed as Wi-Fi Direct. Wi-Fi Direct is a function that allows a Wi-Fi Direct-enabled device to establish its own Wi-Fi network without the need for an Internet connection. Specifically, Wi-Fi Direct-enabled devices such as the mobile terminal device 104 and the MFP 100 can be directly connected to each other even in an environment where the AP 101 or the like is not present.

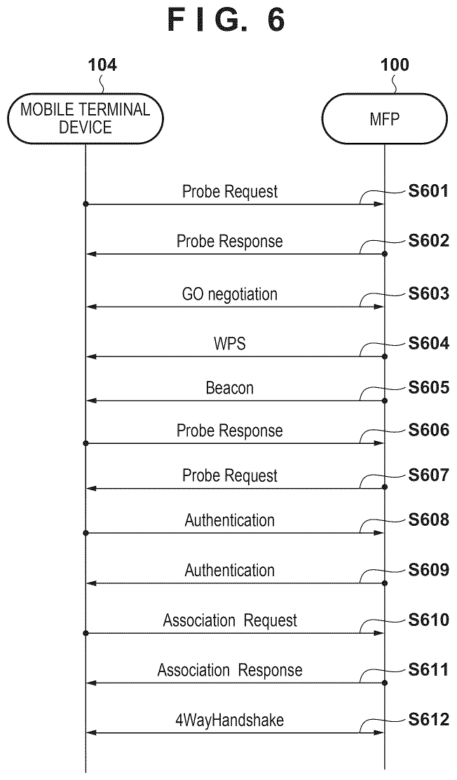

FIG. 6 is a sequence diagram of processing in which the mobile terminal device 104 and the MFP 100 connect in conformity with the WFD standard. Here, a processing sequence for WFD R1 (Release 1) is shown. The processing executed by each device in this sequence is realized by the CPU of each device reading out various programs stored in a memory such as a ROM of each device into a RAM and executing the programs.

For example, the mobile terminal device 104 and the MFP 100 start processing of the sequence by receiving a WFD start instruction from a user. When the mobile terminal device 104 and the MFP 100 receive a WFD start operation from the user, they discover a partner device by repeating a Listen state and a Search state. These states may be preceded by a period of scanning each channel. In the Listen state, for example, channel 1 at 2.4 GHz is selected and a Probe Request frame from another communication device is awaited. In the Search state, a Probe Request frame is transmitted while switching the frequency channel (e.g., channel 1, channel 6, channel 11) and a Probe Response frame is awaited.

In step S601, the mobile terminal device 104 transmits a Probe Request frame to discover a WFD communication device. A Probe Request frame is transmitted to discover a discovered partner device. In this example, it is assumed that the discovering communication device is the mobile terminal device 104 and the discovered communication device is the MFP 100. The Probe Request frame has a WFD attribute (P2P IE), which specifies that the target of discovery is a WFD communication device.

In step S602, upon receiving the Probe Request frame, the MFP 100 transmits a Probe Response frame. Upon receiving a Probe Response frame transmitted by the MFP 100, the mobile terminal device 104 detects the MFP 100, which is a WFD communication partner. Note that the Probe Request frame and the Probe Response frame include a P2P IE and may also include a Multi-Link element. The Multi-Link element can include communication parameters used for multi-link communication defined in the IEEE 802.11be standard. This makes it possible to set a plurality of links between communication devices with one connection procedure. In this way, in WFD R1, the presence of other communication device can be detected by using first discovery processing that uses Probe Request/Response frames. The first discovery processing described above is the discovery sequence for WFD R1.

In step S603, the mobile terminal device 104 and the MFP 100 perform GO Negotiation processing. The channel to be used in direct wireless communication may be determined in GO Negotiation. In the GO Negotiation processing, the mobile terminal device 104 and the MFP 100 transmit or receive a GO Negotiation Request/Response frame that includes an intent value indicating the degree to which they want to become the GO. The GO Negotiation Request/Response frames determine the roles of P2P Group Owner (GO) and P2P client. In addition, the MFP 100 may start up as a fixed master station (GO) in the WFD mode (Autonomous Group Owner). In this case, GO Negotiation processing for determining the role is not required. By setting its own intent value to the maximum of 15, the MFP 100 may execute the GO Negotiation processing such that it always operates as a GO. In this case, the MFP 100, as the master station, determines the frequency band and frequency channel to be used in direct wireless communication. In this case, the MFP 100 can select whether to use the 2.4-GHz or 5-GHz frequency band, and can select which frequency channel to use within that frequency band.

In step S604, the mobile terminal device 104 and the MFP 100 exchange communication parameters by Wi-Fi Protected Setup (WPS) processing. The communication parameters can include parameters used for wireless communication, such as an SSID (Service Set Identifier (SSID), an encryption method, an encryption key, an authentication method, an AKM, a BSSID, and a MAC Address. AKM stands for Authentication and Key Management. AKM indicates the authentication protocol and key exchange algorithm used in wireless communication. For example, in the case where the AKM is “SAE”, the communication parameters may include a password for connecting to an AP or GO that supports Wi-Fi Protected Access (WPA) 3. Also, in the case where the AKM is “psk”, the communication parameters may include a Pre Shared Key (PSK)/passphrase for connecting to an AP or GO that supports WPA2. In the case where the AKM is “1X”, it may include an ID, password, public key, or the like for connecting to an AP that supports WPA-Enterprise. Note that the password and PSK/passphrase are encryption keys used for authentication and key exchange based on WPA or IEEE 802.11. The processing by WPS in step S604 is the communication parameter exchange sequence of WFD R1. Also, from the processing in step S604 and onward, the channel used for communication may be changed from the channel used in steps S601 to S603.

When the MFP 100 determines in step S605 that the MFP 100 itself operates as a GO, the MFP 100 starts transmitting a Beacon frame. The Beacon frame may include communication parameters for communicating with the MFP 100. The Beacon frame can also include Information Elements and Attributes defined in the WFD standard. This allows a communication device other than the mobile terminal device 104 to detect the presence of the MFP 100 and establish a direct wireless communication connection with the MFP 100. For example, the other communication device can detect the presence of the MFP 100 by receiving a Beacon frame that includes information defined in the WFD standard.

In step S606, the mobile terminal device 104 transmits a Probe Request frame to execute a connection procedure with the MFP 100. Upon receiving the Probe Request frame, the MFP 100 transmits a Probe Response frame in step S607.

In step S608, the mobile terminal device 104 transmits an Authentication frame. In step S609, upon receiving the Authentication frame, the MFP 100 transmits the Authentication frame.

In step S610, upon receiving the Authentication frame, the mobile terminal device 104 transmits an Association Request frame. In step S611, upon receiving the Association Request frame, the MFP 100 transmits an Association Response frame.

In step S612, the mobile terminal device 104 and the MFP 100 execute a 4-Way Handshake. By executing such a connection procedure, a connection between the mobile terminal device 104 and the MFP 100 is established.

Although not shown in the above sequence, the mobile terminal device 104 and the MFP 100 may also transmit or receive Provision Discovery Request/Response frames. In addition, the above-described processing of the mobile terminal device 104 and the MFP 100 may be reversed.

### Connection Processing of New WFD Standard

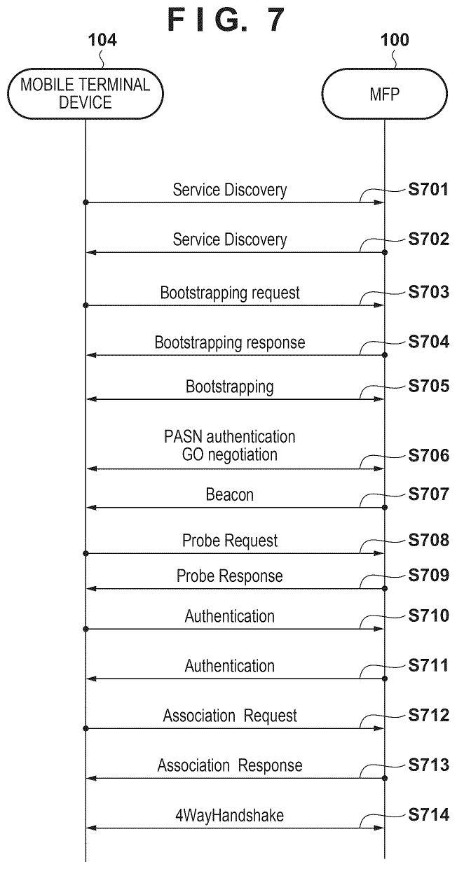

FIG. 7 is a sequence diagram of processing in which the mobile terminal device 104 and the MFP 100 connect to each other in conformity with the WFD standard. Here, the processing sequence for WFD R2 (Release 2) is shown. The processing executed by each device in this sequence is realized by the CPU of each device reading out various programs stored in a memory such as a ROM of each device into a RAM and executing the programs.

For example, the mobile terminal device 104 and the MFP 100 start the processing of the sequence by receiving a WFD start instruction from a user. In the discovery sequence of WFD R2, second discovery processing is performed. An example of a discovery procedure according to the second discovery processing is shown. In this discovery procedure, each of the mobile terminal device 104 and the MFP 100 executes processing based on whether the device is a service-providing communication device or a service-requesting communication device, and detects other communication devices. The service-providing communication device may be called a Publisher, Listener, Advertiser, or the like. In addition, the service-requesting communication device may be called a Subscriber, Searcher, Seeker, or the like. For example, a service-requesting communication device may transmit a frame for detecting other communication devices. In addition, a service-providing communication device can receive and respond to frames transmitted by other communication devices. The role assigned to a communication device may be determined by a higher layer (such as a service layer). In FIG. 7, an example will be described in which the mobile terminal device 104 operates as a service-requesting communication device, and the MFP 100 operates as a service-providing communication device. For example, the mobile terminal device 104 performs a detection operation intermittently and transmits frames for detecting other communication devices. In the second discovery processing, for example, the mechanism of the Wi-Fi Aware standard established by the Wi-Fi Alliance may be used. That is, the frames communicated in the second discovery processing may be frames defined in the Wi-Fi Aware standard. In addition, there is no limitation to the Wi-Fi Aware standard, and other service discovery protocols and methods may be used in the second discovery processing.

In step S701, the mobile terminal device 104 transmits a Service Discovery frame to discover a WFD communication device. Here, Service Discovery is transmitted on channel 6 of 2.4 GHz. The device discovers a discovered partner device by transmitting a Service Discovery frame. Here, it is assumed that the discovering communication device is the mobile terminal device 104 and the discovered communication device is the MFP 100. The Service Discovery frame has a WFD attribute, which specifies that the target of discovery is a WFD communication device.

In step S702, upon receiving the Service Discovery frame, the MFP 100 transmits the Service Discovery frame. The Service Discovery frame transmitted here can be called SDF Follow up. Upon receiving the Service Discovery frame, the mobile terminal device 104 detects the MFP 100 that is the communication partner of the WFD. The second discovery processing described above is the discovery sequence of WFD R2. Since the first discovery processing of WFD R1 and the second discovery processing of WFD R2 are different in method, a communication device that only supports WFD R1 cannot be discovered using the method of WFD R2. Conversely, a communication device that only supports WFD R2 cannot be discovered using the WFD R1 method.

In step S703, the mobile terminal device 104 transmits a request using a Bootstrapping Request frame. The requirement here is a requirement regarding an exchange method for exchanging communication parameters. The mobile terminal device 104 can use this frame to notify the MFP 100 of a communication parameter exchange method that the mobile terminal device 104 can execute, from among communication parameter exchange methods using, for example, a press of a button, a pin code, a passphrase, a QR code (registered trademark), an NFC tag, and the like. For example, in the case where the mobile terminal device 104 is capable of executing an exchange method using a QR code, it can indicate that the mobile terminal device 104 is capable of at least one of displaying and reading a QR code. In addition, in the case where the mobile terminal device 104 is capable of executing an exchange method using a passphrase, it can indicate whether it can use either or both of a character string and a numeric value. Note that in the case where the mobile terminal device 104 is capable of executing an exchange method using a passphrase, it can indicate at least one of whether the passphrase can be displayed or input. In addition, the mobile terminal device 104 can indicate whether or not a button press is enabled to trigger exchange of communication parameters. The information that the mobile terminal device 104 can perform notification of is not limited to the above.

In step S704, in response to the request using the Bootstrapping Request frame, the MFP 100 transmits a response to the mobile terminal device 104 using a Bootstrapping Response frame. As an example, the MFP 100 can select an exchange method that the MFP 100 can execute from among the exchange methods included in the request from the mobile terminal device 104, and send a response including information by which the exchange method can be specified. In addition, in the case where there is no exchange method that can be executed by the MFP 100 among the exchange methods included in the request, the MFP 100 can send a response including information indicating that fact.

In step S705, Bootstrapping processing is performed using the exchange method for exchanging the communication parameters determined between the communication devices, and exchange of the communication parameters is executed. For example, the MFP 100 displays a QR code, and the mobile terminal device 104 reads the QR code to exchange communication parameters. The Bootstrapping processing in step S705 is the communication parameter exchange sequence of WFD R2.

In step S706, mutual authentication may be performed using PASN authentication. PASN stands for Preassociation Security Negotiation. The communication parameters for using the PASN may include the public key of each communication device and the like. Communication parameters for using the PASN may be exchanged using a method not defined in the WFD standard, such as Bluetooth. As another exchange method, a temporary network including the AP may be formed, and the communication device may acquire the communication parameters by connecting to the network. In PASN, the mobile terminal device 104 and the MFP 100 can perform GO Negotiation processing. The channel to be used in direct wireless communication may be determined in GO Negotiation. During the GO Negotiation processing, the roles of P2P Group Owner (GO) and P2P client are determined. In addition, the MFP 100 may start up as a fixed master station in the WFD mode (Autonomous Group Owner). In this case, GO Negotiation processing for determining the role is not required. The MFP 100 may set its own intent value to the maximum of 15 such that it executes the GO Negotiation processing but always operates as the MFP 100. In this case, the MFP 100, as the master station, determines the frequency band and frequency channel to be used in direct wireless communication. For this reason, the MFP 100 can select which frequency band to use out of 2.4 GHz, 5 GHz, or 6 GHz, and which frequency channel to use within that frequency band. In WFD R1, the frequency bands available for direct wireless communication were 2.4 GHz and 5 GHz, but in WFD R2, the frequency bands available for direct wireless communication are 6 GHz, in addition to 2.4 GHz and 5 GHz. Also, unlike WFD R1, in WFD R2, roles are determined after exchanging communication parameters. From the processing of step S707 and onward, the channel used for communication may be changed from the channel used in steps S701 to S706.

When the MFP 100 determines in step S707 that the MFP 100 operates as a GO, the MFP 100 starts transmitting Beacon frames. The Beacon frame may include communication parameters for communicating with the MFP 100. The Beacon frame can also include Information Elements, Attributes, and the like defined in the WFD standard. This allows communication devices other than the mobile terminal device 104 to detect the presence of the MFP 100 and connect to the MFP 100. For example, other communication devices can detect the presence of the MFP 100 by receiving a Beacon frame that includes information defined in the WFD standard.

In step S708, the mobile terminal device 104 transmits a Probe Request frame to execute a connection procedure with the MFP 100. Upon receiving the Probe Request frame, the MFP 100 transmits a Probe Response frame in step S709.

In step S710, the mobile terminal device 104 transmits an Authentication frame. In step S711, upon receiving the Authentication frame, the MFP 100 transmits the Authentication frame.

In step S712, upon receiving the Authentication frame, the mobile terminal device 104 transmits an Association Request frame. In step S713, upon receiving the Association Request frame, the MFP 100 transmits an Association Response frame.

In step S714, the mobile terminal device 104 and the MFP 100 execute a 4-Way Handshake. By executing such a connection procedure, a connection between the mobile terminal device 104 and the MFP 100 is established.

The above-described processing of the mobile terminal device 104 and the MFP 100 may also be reversed. It is also possible to indicate whether a device supports WFD R1 or WFD R2 in P2P IE.

### Description of Embodiments

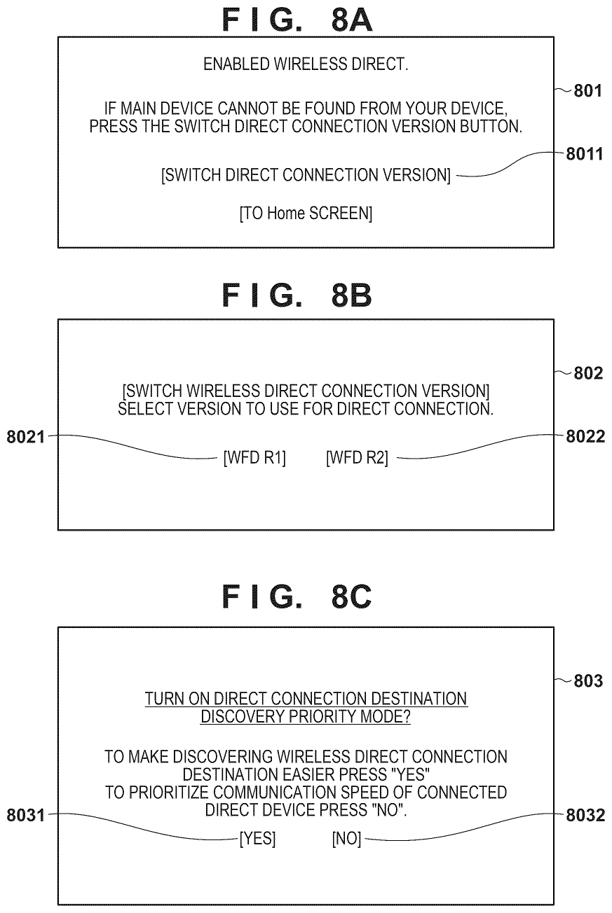

Hereinafter, an embodiment of the present invention will be described with reference to FIG. 8A and onward.

FIGS. 8A to 8C are diagrams showing guide screens on the operation display unit 220 of the MFP 100 that notify the user when the wireless direct mode is enabled. The guide screen displays messages as well as display items for accepting instructions and selections from the user. Note that the wireless direct mode is a wireless communication mode in which communication is performed by wireless direct. In addition, a communication device operating in the wireless direct mode, such as an electronic device that communicates with the MFP 100 by wireless direct, or the mobile terminal device 104, is referred to as a direct device in some cases. In addition, the wireless communication mode is referred to as the communication method in some cases. For example, the wireless infrastructure mode is referred to as a first communication method, and the wireless direct mode is referred to as a second communication method in some cases. In addition, a device a device that supports wireless direct mode such as the MFP 100 is referred to as an electronic device, and a device such as a mobile terminal device that is a communication partner (or communication destination) of the electronic device is referred to as an external device in some cases.

FIG. 8A shows a version switching guide screen 801 that is displayed on the MFP 100 when the wireless direct mode in which the MFP 100 directly communicates wirelessly with an external device is enabled. For example, in the case where the wireless direct mode is enabled during wireless infrastructure mode operation, the version of the wireless direct mode with which the last connection was established can be activated.

However, in the case where WFD R2 is enabled in the MFP 100, if a direct device such as the mobile terminal device 104 does not support WFD R2, the MFP 100 cannot be detected. For this reason, this guide screen is displayed to notify the user of what to do in the case where WFD R2 is not supported. In the case where the user selects to switch the version for wireless direct connection by, for example, performing a tap operation on “switch direct connection version” 8011, the user selects either WFD R1 8021 or WFD R2 8022 on a version selection screen 802 in FIG. 8B. At this time, the currently-enabled version may be displayed in a selected state. That is, FIGS. 8A and 8B are screens (or user interfaces) that display specific display content related to switching from one version of the wireless direct mode to the other version to be enabled.

FIG. 8C shows a guide screen 803 that is displayed on the operation display unit 220 in the case where the wireless infrastructure mode is disabled in a case where the wireless infrastructure mode and the wireless direct mode are operating at the same time. When wireless infrastructure mode and wireless direct mode are operating at the same time, either WFD R1 or WFD R2 operates in the wireless direct mode. At this time, in the case where the wireless infrastructure mode is disabled, the other version that is not in operation in the wireless direct mode can be started up. When [Yes] 8031 is selected, WFD R1 and R2 operate at the same time, making it easier for direct devices to discover the MFP 100. However, there is a possibility that simultaneous operation will influence throughput. For this reason, in the case where the communication speed of an already-connected direct device is to be prioritized, [No] 8032 can be selected to allow the currently-operating version of WFD to operate independently.

Note that settings including disabling the wireless infrastructure mode can be performed on the communication setting menu screen (also called the communication setting screen) in FIG. 3C. The guide screen 803 shown in FIG. 8C may be displayed after an operation to disable the wireless infrastructure mode is performed on the communication setting screen. On the other hand, when an operation to enable the wireless infrastructure mode is performed on the communication setting screen, if both WFD R1 and WFD R2 are operating at that time, the version selection screen 802 in FIG. 8B may be displayed to allow the user to select the preferred version for continuing operation. However, since the preferred version may change depending on the version supported by the direct device, it does not need to be possible to set it on the communication setting screen of FIG. 3C.

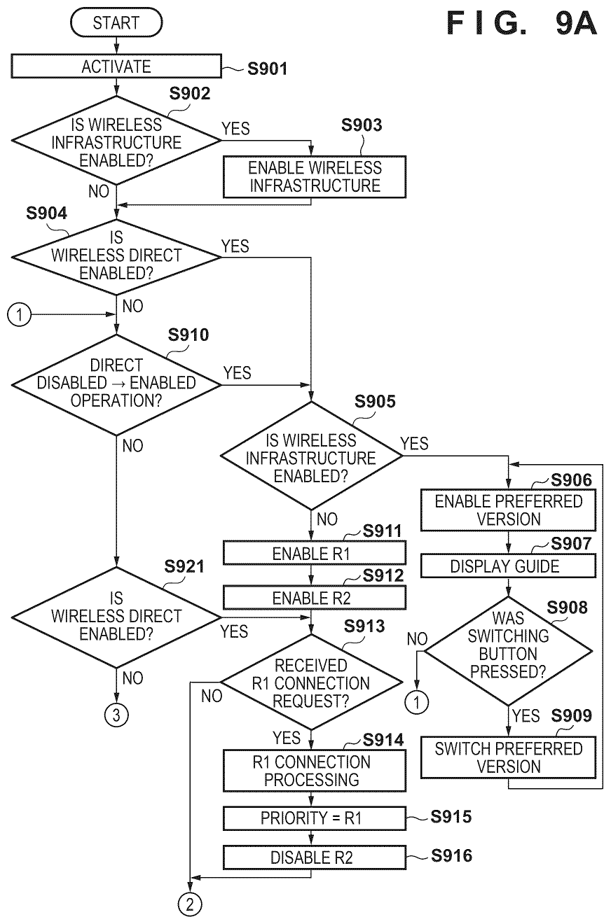

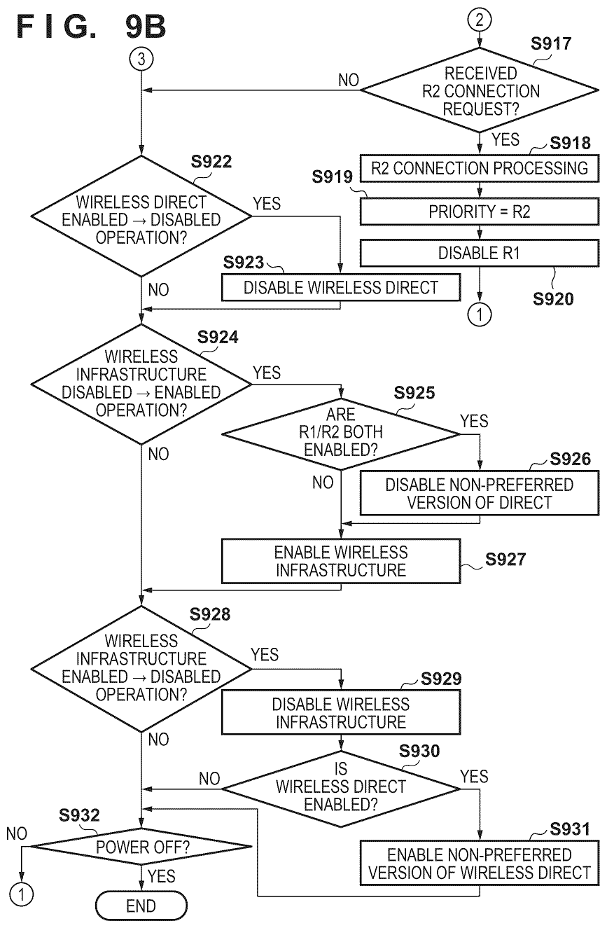

The communication mode setting performed on the communication setting screen of FIG. 3C is stored in the non-volatile memory 215. The stored communication mode setting is referred to in the processing shown in FIGS. 9A and 9B, which will be described later, or is changed therein in response to the screen operations of FIGS. 8A to 8C. The stored communication mode setting includes a wireless infrastructure mode setting that indicates whether the wireless infrastructure mode is enabled or disabled. The stored communication mode setting further includes a wireless direct mode setting indicating whether the wireless direct mode is enabled or disabled. Since the MFP 100 of the present embodiment supports versions R1 and R2 of the wireless direct mode, in the case where the wireless direct mode setting is “enabled”, the wireless direct modes of either or both version are enabled. In the case where the wireless direct mode of either version is enabled, the enabled version is referred to as the preferred version. In the present embodiment, information indicating the preferred version is stored in the non-volatile memory 215, for example. The pieces of information indicating the wireless infrastructure mode setting, the wireless direct mode setting, and the preferred version are stored in predetermined storage locations and are accessible from the program.

FIGS. 9A and 9B are flowcharts showing the processing performed by the MFP 100 when two functions out of the functions of the wireless infrastructure mode, the conventional standard WFD R1, and the new standard WFD R2 are operated at the same time. This flowchart is realized by the CPU 212 loading a program stored in a non-volatile memory such as the ROM 213 or the non-volatile memory 215 into the RAM 214 and executing the commands therein.

First, in step S901, the MFP 100 is started up by a user operation or the like. In step S902, the CPU 212 determines whether or not the wireless infrastructure mode has been set to be enabled. This determination can be made, for example, by referring to the wireless infrastructure mode setting stored in the non-volatile memory 215. Here, in the case where the wireless infrastructure mode is set to be enabled, that is, in the case where it is determined that the wireless infrastructure is set to be enabled, the CPU 212 enables the wireless infrastructure mode in step S903. At this time, by inputting connection parameters of the AP 101 from the operation display unit 220, the MFP 100 becomes able to receive Beacon frames from the AP 101 in the enabled wireless infrastructure mode. Upon receiving the Beacon frame, the MFP 100 transmits a connection request to the AP 101. When a connection with the AP 101 is established, the MFP 100 can perform wireless communication via the AP 101.

In step S904, the CPU 212 refers to the wireless direct mode setting stored in the non-volatile memory 215 to determine whether or not the wireless direct mode is enabled. In the case where it is determined that the wireless direct mode is enabled, the processing proceeds to step S905. On the other hand, in the case where it is determined that the wireless direct mode is not enabled (that is, it is disabled), the processing proceeds to step S910.

In step S905, the CPU 212 determines whether or not the wireless infrastructure mode is enabled by referring to the wireless infrastructure mode setting. In the case where it is determined that the wireless infrastructure mode is enabled, the processing proceeds to step S906. On the other hand, in the case where it is determined the wireless infrastructure mode is disabled, the processing proceeds to step S911.

In step S906, the CPU 212 enables the wireless direct mode of the preferred version, that is, either WFD R1 or WFD R2. Here, out of WFD R1 and WFD R2, the preferred version in which a connection with the mobile terminal device 104 was last established may be enabled. In this case, the wireless direct mode of the stored preferred version may be enabled by referring to the preferred version stored in step S915, step S909, step S919, or the like, which will be described later. Also, WFD R2 may be set or enabled as the preferred version by default.

In the case where WFD R2, that is, version R2 of the wireless direct mode, is started up in step S906, the mobile terminal device 104 used by the user may not support WFD R2. If the mobile terminal device 104 does not support WFD R2, the MFP 100 cannot be detected from the mobile terminal device 104. For this reason, in step S907, the CPU 212 displays the version switching guide screen 801 in FIG. 8A on the operation display unit 220. The user judges whether or not to switch the WFD version, and in the case where switching is to be performed, the user taps [switch direct connection version] 8011 in FIG. 8A, that is, presses the switch button, or the like to select switching. In the case where switching is not be performed, it is sufficient to press [Go to Home Screen].

In step S908, the CPU 212 determines whether the switch button has been pressed in FIG. 8A, that is, whether or not switching of the preferred version has been selected. In the case where it is determined that switching of the preferred version has been selected, the processing proceeds to step S909, and in the case where switching has not been selected, the processing proceeds to step S910. Note that cases where switching of the preferred version is not selected may include, for example, a case where [Go to Home Screen] 8011 is selected, or a case where a predetermined time has elapsed while the version switching guide screen 801 is displayed without any version switching operation being performed.

In step S909, the CPU 212 first displays the version selection screen 802 in FIG. 8B, and enables the wireless direct mode of the version selected on the version selection screen 802, that is, either WFD R1 or WFD R2. Additionally, the preferred version stored in the non-volatile memory 215 is updated with the selected version. When WFD R1 is enabled, the MFP 100 transmits a Beacon frame conforming to the R1 standard. When the mobile terminal device 104 receives this Beacon frame, it transmits a Probe Request to the MFP 100. This corresponds to step S601 in FIG. 6. When the MFP 100 receives a Probe Request, the MFP 100 transmits a Probe Response. This corresponds to step S602 in FIG. 6. This enables the MFP 100 to detect the mobile terminal device 104.

In addition, when WFD R2 is enabled in step S909, the MFP 100 transmits a Beacon frame conforming to the version R2 standard. The WFD R2 Beacon frame conforms to the WFD standard. Therefore, it may include Information Elements, Attributes, and the like defined in the WFD standard. Furthermore, it may also include WFD R2 compatibility information. The MFP 100 waits for a Service Discovery frame, transmits a Service Discovery frame, or simultaneously performs the above-mentioned waiting and transmission. Here, after receiving a Service Discovery frame transmitted by the mobile terminal device 104 in order to search for the mobile terminal device 104, the MFP 100 transmits a Service Discovery frame to the mobile terminal device 104 in response. These correspond to steps S701 and S702 in FIG. 7. This enables the mobile terminal device 104 to detect the WFD R2 of the MFP 100.

The connection processes for WFD R1 and WFD R2 from the above and onward follow FIGS. 6 and 7, respectively. However, in the case where the MFP 100 starts up as a fixed master station (Autonomous Group Owner), the role has already been determined and therefore GO Negotiation processing is not required. On the other hand, in the case where the MFP 100 does not start up as a GO, GO Negotiation processing is executed.

After switching the WFD version, the CPU 212 returns to step S906 and displays the version switching guide screen 801 in FIG. 8A again. The processing of steps S906 to S909 is repeated as long as the WFD version is being switched, and in the case where it is determined in step S908 that switching of the WFD version has not been selected, the processing proceeds to step S910.

On the other hand, in the case where it is determined in step S905 that the wireless infrastructure mode setting is disabled, the CPU 212 enables WFD R1 in step S911, and subsequently, the CPU 212 enables WFD R2 in step S912. Additionally, the setting value of the wireless direct mode setting may be rewritten to “enabled” in either step S911 or step S912. However, in the case where the setting value of the wireless direct mode setting has already been changed to “enabled” by a setting change operation, this rewriting processing does not need to be performed.

In step S913, the CPU 212 determines whether or not a connection request for WFD R1 has been received while WFD R1 is enabled. The connection request for WFD R1 is the Probe Request described with reference to FIG. 6, and in step S913, it is determined whether it has been received. In the case where a connection request for WFD R1 has been received, the processing proceeds to step S914, and if not, the processing proceeds to step S917 (FIG. 9B). Note that in step S913, in the case where WFD R1 has not been enabled (in the case where WFD R1 has been disabled), the result of the determination is No (i.e., not received).

In step S914, the CPU 212 performs connection processing for the wireless direct mode version R1. This processing is the processing described with reference to FIG. 6. Since reception of the Probe Request was confirmed in step S913, the processing of S602 and onward need only be performed. When a connection with the connection partner (or connection destination), in this case a WFD R1 connection with the mobile terminal device 104, is established, in step S915, the CPU 212 sets the WFD version to be preferentially activated when the WFD is started up to R1 (stores R1 as the preferred version). In step S916, the CPU 212 disables WFD R2. This prevents WFD R2 Beacon frames from being transmitted. This causes the mobile terminal device 104 to stop transmitting connection requests. Even if a connection request is received, it will be rejected by the MFP 100 and connection processing will not be performed.

In step S917 in FIG. 9B, the CPU 212 determines whether or not a connection request for WFD R2 has been received while WFD R2 is enabled. Receiving a connection request for WFD R2 corresponds to receiving Service Discovery in step S701 described with reference to FIG. 7. In the case where a connection request for WFD R2 has been received, the processing proceeds to step S918, and if not, the processing proceeds to step S922. In step S917, in the case where WFD R2 is not enabled (in the case where WFD R2 is disabled), the result is determined as No.

In step S918, the CPU 212 performs connection processing for WFD R2. This processing is the processing shown in FIG. 7. Here, in the case where Bootstrapping is to be performed by displaying and reading a QR code, the CPU 212 displays the QR code on the operation display unit 220. The mobile terminal device 104 activates the camera to capture an image, reads it, and performs Bootstrapping. This corresponds to steps S703 to S705 in FIG. 7. This establishes a connection between the MFP 100 and the mobile terminal device 104 in the wireless direct mode of version R2 (WFD R2).

When a connection in WFD R2 is established, in step S919, the CPU 212 stores version R2 as the preferred version. Thereafter, in step S920, the CPU 212 disables WFD R1. As a result, Beacon frames of WFD R1 are no longer transmitted, and connection requests from the mobile terminal device 104 are no longer received. The processing then proceeds to step S910.

In step S910, the CPU 212 determines whether or not an operation for switching the wireless direct mode from disabled to enabled has been performed on the operation display unit 220. In the case where it is determined that a switching operation has been performed, the processing proceeds to step S905, and if not, the processing proceeds to step S921. Note that in the determination in step S910, the communication setting screen in FIG. 3C is opened by a user operation and the relevant operation is then performed. Alternatively, in the case where the wireless direct mode is currently disabled but the current setting value of the wireless direct mode setting is “enabled”, it may be determined that an operation to switch the wireless direct mode from disabled to enabled has been performed. The same is true for step S922, although enabled and disabled are reversed. In step S905 branched from step S910, the CPU 212 performs the processing for determining whether the wireless infrastructure mode is enabled or disabled, as already described.

On the other hand, in step S921, the CPU 212 determines whether or not the wireless direct mode is enabled. This determination may be made by referring to the wireless direct setting stored in the non-volatile memory 215. In the case where it is determined that the wireless direct mode is enabled, the processing proceeds to S913, and in the case where it is determined that the wireless direct mode is not enabled, the processing proceeds to S922 shown in FIG. 9B.

In step S922, the CPU 212 determines whether or not an operation for switching the wireless direct mode from enabled to disabled has been performed on the operation display unit 220. This setting can be changed on the communication setting screen shown in FIG. 3C. In the case where a switching operation for switching the wireless direct mode to disabled has been performed, the processing proceeds to step S923, and in the case where a switching operation has not been performed, the wireless direct mode remains enabled and the processing proceeds to step S924. In step S923, the CPU 212 disables the wireless direct mode. This will prevent Beacon frames from being transmitted for WFD R1 and WFD R2. In addition, connection requests from the mobile terminal device 104 are no longer received. Along with this, in step S923, the CPU 212 rewrites the setting value of the wireless direct setting in the non-volatile memory 215 from “enabled” to “disabled”. However, in the case where the setting value of the wireless direct mode setting has already been changed to “disabled” through a setting change operation, this rewriting processing does not need to be performed.

In step S924, the CPU 212 determines whether or not an operation for switching the wireless infrastructure mode from disabled to enabled has been performed on the operation display unit 220. Note that in the determination in step S924, the communication setting screen of FIG. 3C is opened through a user operation and the relevant operation is then performed. Alternatively, if the current wireless infrastructure mode is disabled but the current setting value of the wireless infrastructure mode setting is enabled, it may be determined that an operation for switching the wireless infrastructure mode from disabled to enabled has been performed. The same is true for step S928, although enabled and disabled are reversed. In the case where an operation for switching the wireless infrastructure mode from disabled to enabled has been performed, the processing proceeds to step S925, and in the case where no operation has been performed, the processing proceeds to step S928.

In step S925, the CPU 212 determines whether both WFD R1 and WFD R2 are enabled or whether at least one of them is disabled. If both WFD R1 and WFD R2 are enabled, the processing proceeds to step S926, and if at least one of them is disabled, the processing proceeds to step S927.

In step S926, the CPU 212 disables the wireless direct mode of the version that is not the preferred version. At this time, the disabled version may be displayed on the operation display unit 220. In addition, in the case where only one of WFD R1 and WFD R2 is enabled, or in the case where both are disabled, the CPU 212 enables the wireless infrastructure mode in step S927. At the same time, the setting value of the wireless infrastructure mode setting in the non-volatile memory 215 is rewritten to “enabled”. However, in the case where the setting value of the wireless infrastructure mode has already been changed to “enabled” through a setting change operation, this rewriting processing does not need to be performed. As a result, if any version of the wireless direct mode is enabled, the MFP 100 is in a state in which the wireless infrastructure mode and the wireless direct mode are operating at the same time.

On the other hand, in the case where the operation for switching the wireless direct mode from enabled to disabled has not been performed in step S924, the processing proceeds to step S928.

In step S928, the CPU 212 determines whether or not an operation for disabling the wireless infrastructure mode has been performed on the operation display unit 220. In the case where an operation for disabling the wireless infrastructure mode has been performed, the processing proceeds to step S929, and if not, the processing proceeds to step S932.

In step S929, the CPU 212 disables the wireless infrastructure mode. Additionally, the setting value of the wireless infrastructure mode is rewritten to “disabled”. However, in the case where the setting value of the wireless infrastructure mode has already been set to “disabled” through a setting change operation, this rewriting processing does not need to be performed.

In step S930, the CPU 212 determines whether or not the wireless direct mode setting is enabled. In the case where the wireless direct mode setting is enabled, the processing proceeds to step S931, and in the case where it is not enabled, that is, in the case where it is disabled, the processing proceeds to step S932. In step S931, the CPU 212 enables the non-preferred version of the wireless direct mode. At this time, a guide screen 803 in FIG. 8C may be displayed, and the user may input whether or not to enable the non-preferred version of the WFD. In this case, in the case where “Yes” 8031 on the guide screen 803 has been selected, the CPU 212 enables the wireless direct mode of the version that is not the preferred version in step S931. If the case where “No” 8032 has been selected, the processing may proceed to step S932 without anything being done. By operating the WFD R1 and the WFD R2 at the same time, it is easier for the mobile terminal device 104 to discover the MFP 100. This allows the MFP 100 to be detected even if the direct device does not support WFD R2. On the other hand, in the case where the communication speed of the currently-connected direct device is to be prioritized, the preferred version of the wireless direct mode may be operated alone.

In step S932, the CPU 212 determines whether to power off the MFP 100. In the case where it is powered off, this flowchart ends. In the case where it is not powered off, the processing returns to step S910 and the subsequent processing is performed. Note that powering off can be judged by an operation for powering off being performed using a power switch. However, this is based on the premise that the power switch is not a hardware switch that mechanically cuts off the power supply. When the power is turned off, all wireless communication is stopped, other necessary processing is performed, and the supply of power to the MFP 100 is stopped.

Note that in FIG. 9A, step S907 is executed unconditionally after step S906, but steps S907 to S909 may be executed only in the case where the version of the wireless direct mode enabled in step S906 is WFD R2. This is based on the premise that although the mobile terminal device 104 supports WFD R1, it may or may not support WFD R2. In the case where a version of the wireless direct mode that may not be supported by the mobile terminal device 104 is enabled, it is sufficient to be able to switch the enabled version, and therefore steps S907 to S909 may be executed conditionally as described above.

In addition, in the case where the wireless infrastructure mode setting is disabled and connections to both WFD R1 and WFD R2 are established, WFD R1 and WFD R2 may continue to operate at the same time without disabling either one of them in step S916 or step S920.

### Advantageous Effects of the Above Embodiment

In the case where a wireless chip, that is, the wireless unit 226, is weak, that is, has low processing performance or communication performance, it may be difficult to operate the three modes at the same time when operating the wireless infrastructure mode and the wireless infrastructure modes of the two versions, namely R1 and R2, in parallel. Even if they can be operated, it may not be possible to achieve their respective performances.

Here, a weak wireless chip includes not only a case where the processing performance of the wireless unit is low, but also a case where the communication capability is limited due to antennas being few in number, for example, there being only one antenna. In this case, communication in a plurality of communication modes is performed in a time-division manner, and the communication time in one communication mode is shortened. For this reason, operating a plurality of communication modes simultaneously at the same time will result in reduced performance. In the case where the wireless chip does not have sufficient processing capability, trying to run a plurality of functions at the same time often does not work.

In this way, in the case where resources for communication are limited, in particular, in the case where the wireless chip is weak, the number of wireless communication modes executed at the same time is limited, thereby suppressing deterioration of the wireless communication performance. The number of wireless communication modes that can be executed at the same time is limited to two.

More specifically, in this embodiment, in the case where the wireless direct function is enabled while the wireless infrastructure mode is disabled, the wireless communication modes of both WFD R1 and WFD R2 are enabled. In the case where the wireless direct mode is to be enabled while the wireless infrastructure mode is enabled, either WFD R1 or WFD R2 is enabled. By doing this, even if there are limitations to the wireless chip, it is possible to prevent a decrease in performance by limiting the number of communication modes that can be enabled at the same time to two.

In addition, in the case where the wireless infrastructure mode and WFD R2 are operated at the same time, WFD R1 is disabled, and in the case where the wireless infrastructure mode and WFD R1 are operated at the same time, WFD R2 is disabled. The user can choose which one to disable. Thereafter, in the case where wireless infrastructure mode is disabled, wireless direct mode (WFD R1 or WFD R2) that was disabled is enabled. At this time, a guide screen that presents the user with the option of whether or not to enable the wireless direct mode and allows the user to select it may be displayed. In this way, by enabling the upper limit of the number of communication modes that can be used, it is possible to effectively utilize a given communication capability and further increase the number of opportunities for connection with an external device.

Furthermore, in the wireless direct mode, in the case where the MFP cannot be detected by an external device such as a mobile terminal device that is to communicate with the MFP, the enabled version of the wireless direct mode is switched (from WFD R1 to WFD R2, or from WFD R2 to WFD R1). Furthermore, a guide screen for switching may be displayed, and the user may be allowed to switch by operating a displayed switching button. In this way, by switching from one version of the wireless direct mode in which an external device cannot be detected to another version, it is possible to increase the number of opportunities to detect an external device even with limited communication capabilities.

Furthermore, in the case of performing operation in the wireless direct modes of version R1 and version R2 at the same time, if connection is established in the wireless direct mode of one version, the wireless direct mode of the other version is turned off. The other wireless direct mode can also be turned off in response to a user operation by displaying a screen for that purpose. As a result, after a connection is established, unused versions of wireless direct modes can be disabled, allowing communication resources to be used for communication through the established connection, thereby improving communication performance.

Furthermore, a priority order is set to give priority to one of the two versions of the wireless direct mode over the other, and in the case where the wireless infrastructure mode is enabled, the version of the wireless direct mode with the lower priority level is disabled. The selection of the preferred version can be performed by the user through a user interface. This makes it possible to preferentially enable the wireless direct mode of the selected version, thereby increasing the number of opportunities to connect with an external device.

As described above, depending on the operation of enabling and disabling the wireless communication mode, including the selection performed by the user, it is possible to execute a more appropriate wireless communication mode in a restricted environment.

Note that restrictions on wireless communication resources, such as the weakness of a wireless chip, can be judged based on the implementation of the type of wireless chip, the number of antennas, and the like. For this reason, in this embodiment, whether or not the wireless chip is weak is not dynamically determined in the processing of, for example, FIGS. 9A and 9B, but it is assumed that the wireless chip is weak based on the implementation of the MFP 100. In response to this, communication resources such as processing power and the number of antennas may be used as index values and compared with thresholds to specify the range of communication performance. In the case where the specified performance is low, control as shown in FIGS. 9A and 9B may be performed, and in the case where it is high, the number of wireless communication modes may not be restricted. In this way, systems with different communication capabilities can perform control using the same program.

Furthermore, in the wireless direct mode, the preferred version is stored in a non-volatile manner, whereby the version that was suitable for the last usage environment of an electronic device such as an MFP can be continuously used even after the electronic device is restarted. This allows the user to use a more efficient communication mode without any hassle in a specification mode where the usage environment does not change.

Note that, with respect to the above description of the processing during reception of print data, the same processing can be applied also to the reception or transmission of data other than print data. For example, the same processing can be applied also when scanning a document with the reading unit 219 and transmitting the scanned image (image data) to the mobile terminal device (104) via the AP.

Note that the various controls described above as being performed by the CPU 212 may be performed by a single piece of hardware, or the entire device may be controlled by a plurality of pieces of hardware (e.g., a plurality of processors or circuits) sharing the processing.

In addition, although the present invention has been described in detail based on its preferred embodiments, the present invention is not limited to these specific embodiments, and various modes that do not deviate from the gist of the present invention are also included in the present invention. Furthermore, the above-described embodiments are merely examples of one embodiment of the present invention, and the embodiments can be combined as appropriate.

In addition, in the above-described embodiment, a case in which the present invention is applied to an MFP has been described as an example, but this is not limited to this example and can be applied to any wireless device that functions as an STA capable of performing processing in response to a request to change the connection destination from an AP. That is, the present invention is applicable to various measurement devices (sensor devices) such as personal computers, PDAs, tablet terminals, mobile phone terminals such as smartphones, music players, game consoles, e-book readers, smart watches, thermometers, and hygrometers. The present invention is also applicable to digital cameras (including still cameras, video cameras, network cameras, and security cameras), printers, scanners, and drones. The present invention is also applicable to video output devices, audio output devices (e.g., smart speakers), media streaming players, and wireless LAN adapters (adapters) that can be connected to USB terminals or LAN cable terminals. Video output devices include, for example, devices such as set-top boxes, which acquire (download) video and still images from the Internet specified by a URL designated by an electronic device, and output them to a connected display device via a video output terminal such as HDMI (registered trademark). This allows streaming playback on a display device and mirroring display (display in which the content displayed on an electronic device is also displayed on a display device). In addition, the video output device includes a media player such as a television, a hard disk recorder, a Blu-ray recorder, a DVD recorder, a head-mounted display, a projector, a television, a display device (monitor), a signage device, and the like. The present invention is also applicable to what are called smart home appliances, such as air conditioners, refrigerators, washing machines, vacuum cleaners, ovens, microwave ovens, lighting appliances, heating appliances, and cooling appliances, which are capable of connecting to Wi-Fi.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-146776, filed on Aug. 28, 2024 which is hereby incorporated by reference herein in its entirety.

What is claimed is:

1. An electronic device comprising:
a communication device capable of
communication using a first communication method of wirelessly communicating with an external device via an external access point, and
communication using a second communication method of wirelessly communicating directly with an external device without going through an external access point;
at least one memory storing instructions; and
at least one processor that is in communication with the at least one memory and that, when executing the instructions, cooperates with the at least one memory to execute processing, the processing including
enabling both a first version and a second version of the second communication method in a case where the communication using the second communication method is enabled while the first communication method is disabled, and
enabling one of the first version and the second version of the second communication method in a case where the communication using the second communication method is enabled while the first communication method is enabled.

2. The electronic device according to claim 1,
wherein the processing includes not accepting a connection request from a connection destination using the second communication method of a version that has not been enabled out of the first version and the second version.

3. The electronic device according to claim 1,
wherein the first communication method and the second communication method are both communication methods performed using a wireless LAN.

4. The electronic device according to claim 1,
wherein the first version and the second version of the second communication method are both Wi-Fi Direct conforming to the IEEE 802.11 series standard.

5. The electronic device according to claim 1,
wherein in the processing, a version of the second communication method that has been disabled out of the first version and the second version is enabled in a case where the first communication method is disabled from an enabled state.

6. The electronic device according to claim 1,
wherein in the processing, a display item for accepting selection by a user of whether or not to enable the disabled version out of the first version or the second version of the second communication method is displayed in a case where the first communication method is disabled from an enabled state.

7. The electronic device according to claim 1,
wherein in the processing, in a case where communication is enabled in the second communication method while the first communication method is enabled, one version out of the first version and the second version of the second communication method is enabled, and specific display content related to switching from the one version that is enabled to another version.

8. The electronic device according to claim 7,
wherein the specific display content includes a guide indicating that the switching is to be performed in a case where a connection cannot be established with an external device that is to be a communication destination in the second communication method.

9. The electronic device according to claim 7,
wherein in the processing, the one version is disabled and the other version is enabled in response to accepting an instruction to perform the switching.

10. The electronic device according to claim 1,
wherein in the processing, both the first version and the second version of the second communication method are enabled while the first communication method is disabled, and then, in a case where a connection is made to a communication partner in one version out of the first version and the second version, the other version is disabled.

11. The electronic device according to claim 1,
wherein in the processing, control is performed such that, in a case where a connection is made to a communication partner in one version out of the first version and the second version after enabling both the first version and the second version of the second communication method while the first communication method is disabled, the version of the second communication method used for the connection is stored as a preferred version, and thereafter, in a case where the second communication method is switched from a disabled state to a enabled state while the first communication method is enabled, the preferred version out of the first version and the second version of the second communication method is enabled and the other version is not enabled.

12. The electronic device according to claim 11,
wherein in the processing, the preferred version is updated such that the version in which connection with a connection destination was last established out of the first version and the second version is the preferred version.

13. The electronic device according to claim 1,
wherein in the processing, in connection processing for establishing connection with a communication destination in the first version, a parameter to be used in the second communication method is transmitted to the communication destination or received from the communication destination after processing for determining which of the electronic device and the communication destination is to be a master device, and
in connection processing for establishing connection with a communication destination in the second version, a parameter to be used in the second communication method is transmitted to the communication destination or received from the communication destination before the processing for determining which of the electronic device and the communication destination is to be a master device.

14. The electronic device according to claim 1,
wherein in communication in the first version, communication using the 6-GHz band is not possible, but in communication in the second version, communication using the 6-GHz band is possible.

15. The electronic device according to claim 1,
wherein in the processing, both the first version and the second version of the second communication method are enabled when the second communication method is enabled and the first communication method is disabled, and the first version is prioritized when connecting to an external device while both the first version and the second version of the second communication method are enabled.

16. A non-transitory computer-readable storage medium storing a program that causes a computer to execute processing when the program is loaded and executed on the computer, which is capable of communication using a first communication method of wirelessly communication with an external device via an external access point and communication using a second communication method of wirelessly communicating directly with an external device without going through an external access point, the processing including:
enabling both a first version and a second version of the second communication method in a case where the communication in the second communication method is enabled while the first communication method is disabled; and
enabling one of the first version and the second version of the second communication method in a case where the communication in the second communication method is enabled while the first communication method is enabled.

17. A control method for an electronic device capable of communication using a first communication method for wirelessly communicating with an external device via an external access point and communication using a second communication method for wirelessly communicating directly with the external device without going through an external access point, comprising:
enabling, by the electronic device, both a first version and a second version of the second communication method in a case where the communication in the second communication method is enabled while the first communication method is disabled; and
performing control, by the electronic device, such that one of the first version and the second version of the second communication method is enabled in a case where the communication in the second communication method is enabled while the first communication method is enabled.
